(19) United States
(12) Patent Application Publication
(10) Pub. No.: US 2025/0011082 A1
(43) Pub. Date: Jan. 9, 2025

(54) LIFTING FRAME ASSEMBLY WITH EXTENDIBLE AND RETRACTABLE GUIDE MEMBERS, CONTAINER HANDLING VEHICLE AND STORAGE SYSTEM, AND ASSOCIATED METHOD

(71) Applicant: Autostore Technology AS, Nedre Vats (NO)

(72) Inventor: Jørgen Djuve Heggebø, Olen (NO)

(73) Assignee: Autostore Technology AS, Nedre Vats (NO)

(21) Appl. No.: 18/710,014

(22) PCT Filed: Nov. 15, 2022
(86) PCT No.: PCT/EP2022/082018

§ 371 Date: May 14, 2024

(30) Foreign Application Priority Data
Nov. 16, 2021 (NO) 20211378

(51) Int. Cl. B65G 1/04; B66C 19/00

(52) U.S. Cl. CPC B65G 1/0464; B66C 19/00

(57) ABSTRACT

A lifting frame assembly, which is for a container lift device of an automated storage system, includes a lifting frame holder, a lifting frame, and at least a first set of guide members. The lifting frame holder is configured to be suspended from the container lift device by lifting bands. The lifting frame holder has a rectangular horizontal outer periphery. The lifting frame includes grippers for connection to a storage container from above. The at least a first set of guide members are for guiding against upright members of a framework structure of the automated storage system. The first set of guide members is operable between: a retracted position where the guide members are retracted within the outer periphery of the lifting frame holder, and an extended position where the guide members extend outside the outer periphery of the lifting frame holder.

### FIELD OF THE INVENTION

The present invention relates to a lifting frame assembly with extendible and retractable guide member and a container handling vehicle as well as a storage system comprising the lifting frame assembly. It is further described a framework structure comprising upright members supporting a two-dimensional rail system arranged across the top of framework structure, wherein the upright members are configured complementary to the guide members such that the lifting frame assembly can be guided by the upright members via the extendible guide members. In addition, is described a method of guiding a lifting frame assembly against upright members of a framework structure.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may further comprise a lifting frame 27 suspended from lifting bands 25. The lifting bands 25 may provide power and communication between the container handling vehicle and the lifting frame 27. The lifting frame 27 may comprise gripping devices 26 for connection to gripping recesses of a storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

A storage system may also use port columns 119,120 to transfer a storage container between the rail system 108 on top of the framework structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

One objective of the invention is to solve at least some of the drawbacks related to prior art solutions.

In particular, it is an objective to provide more access to the containers in at least regions of an automated storage and retrieval system.

### SUMMARY OF THE INVENTION

The present invention is set forth and characterized in the independent claims, while the dependent claims describe other characteristics of the invention.

It is described a lifting frame assembly for a container lift device of an automated storage system, wherein the lifting frame assembly comprises:
a lifting frame holder configured to be suspended from the container lift device by lifting bands, wherein the lifting frame holder has a rectangular horizontal outer periphery;
a lifting frame comprising grippers for connection to a storage container from above;
at least a first set of guide members for guiding against upright members of a framework structure of the automated storage system, and wherein the first set of guide members is operable between:
   a retracted position where the guide members are retracted within the outer periphery of the lifting frame holder, and
   an extended position where the guide members extend outside the outer periphery of the lifting frame holder.

The at least first set of guide members preferably restrict movement of the lifting frame in at least two perpendicular horizontal directions.

The extension and retraction of the guide members of the first set of guide members (and any additional sets of guide members) may be powered via the lifting bands.

In the retracted position the cross-sectional area of the lifting frame is smaller than a cross-sectional area of the access opening of the rail system, such that the lifting frame can pass through the access opening when the guide members are in the retracted position.

When in the extended position, the guide members preferable extend into contact with the upright members such as to obtain satisfactory guiding against the surface of the upright members.

The increased distance between neighboring upright members provides a larger opening such that storage containers can be retrieved not only from above, but also sideways, easing retrieval of storage containers from the storage system compared to the prior art solutions where the storage containers must be lifted to the top of the rail system prior to being transported to a port.

Furthermore, if arranging individual shelves in the columns, the storage containers are independently movable as they are supported on one dedicated shelf and not supported by an underlying storage container nor supporting an overlying storage container as in the prior art solutions.

In addition, if arranging individual shelves in the columns, such a “mini-load system arrangement” where the containers have more space around them, allows the contents of the containers to be chilled down much more easily than conventional stacks of containers where it is much harder to get air to circulate around the containers.

The first set of guide members preferably restrict movement of the lifting frame in in the horizontal plane, i.e. the guide members hold the lifting frame assembly.

The first set of guide members may comprise two guide members arranged in two oppositely arranged corners. The lifting frame assembly may have a rectangular shape and the guide members may be arranged in two oppositely arranged corners of the lifting frame assembly.

The first set of guide members may comprise four guide members, where one guide member is arranged in each corner. The lifting frame assembly may have a rectangular shape and the four guide members may be arranged in each corner of the lifting frame assembly.

The container lift device may be (or may be provided by) a movable container handling vehicle with first and second sets of wheels for guiding the vehicle in the X direction and the Y direction on top of the rail system, a gantry mounted lift device, or a fixed container lift device as disclosed in WO 2020/210558 A1.

The container lift device may comprise a lifting assembly which is suspended from one or more spoolable lifting elements and arranged to be raised or lowered in order to raise or lower a releasably attached storage container within columns formed by the upright members.

The first set of guide members may be arranged on two oppositely arranged side edges of the lifting frame.

The first set of guide members may have a concave surface.

The first set of guide members may comprise a protruding member configured to be received in a complementary vertical groove of the upright members.

The lifting frame assembly may further comprise:
a horizontally movable telescopic part to which the lifting frame and the lifting frame holder are connected;
and wherein the telescopic part is configured to move between a retracted position below the lifting frame holder and an extended position outside a vertical projection of the lifting frame holder.

The lifting frame holder may be linked to the lifting frame by the telescopic part joining one to the other.

The telescopic part may be powered through signal and communication via the lifting bands.

The lifting frame assembly may further comprise a second set of guide members arranged at a vertical distance from the first set of guide members. Using a second set of guide members may assist in preventing that the lifting frame tilts due to torque when the telescopic part is in the extended position.

The second set of guide members may comprise an equal amount of guide members as the first set of guide members. Furthermore, the second set of guide members may be arranged for guiding against the same upright members as the first set of guide members.

It is further described a container handling vehicle for a storage system, wherein the container handling vehicle comprises a first set of wheels for driving in a first direction X and a second set of wheels for driving in a second direction Y perpendicular to the first direction, wherein the container handling vehicle comprises a lifting frame assembly as defined above.

It is further described a framework structure comprising upright members supporting a two-dimensional rail system of the framework structure arranged across the top of framework structure, wherein the upright members are configured to guide the first set of guide members of the lifting frame assembly as defined above.

The upright members may have a convex surface. The surface is preferably complementary to the first set of guide members (and second set of guide members if there is a second set of guide members).

Alternatively, the upright members may comprise a vertical groove extending from an upper part of the upright members and to a lower part of the upright members. The vertical groove is arranged for receiving a complementary protruding member of the guide members of the lifting frame assembly.

It is further described a storage system comprising a framework structure, the framework structure (100) comprising upright members and a two-dimensional rail system arranged across the top of the upright members, the rail system comprises a first set of parallel rails arranged to guide movement of container handling vehicles in a first direction X across the top of the frame structure, and a second set of parallel rails arranged perpendicular to the first set of rails to guide movement of the container handling vehicles in a second direction Y which is perpendicular to the first direction, the first and second sets of parallel rails dividing the rail system into a plurality of access openings in the rail system for lifting and lowering of a storage container between a position above the rail system and a position below the rail system, and wherein the storage system comprises a lifting frame assembly as defined above, a container handling vehicle as defined above and/or a framework structure as defined above.

Each of the upright members of the storage system may have an outwardly protruding or convex surface and the first set of guide members each may have a concave surface oriented against the upright members such that the first set of guide members at least partly enclose the upright members when in the extended position. If a second set of guide members is present, the second set of guide members may also have a concave surface.

Alternatively, each of the upright members may comprise a vertical groove and the first set of guide members each comprises a complementary protruding member.

The protruding member and thus the lifting frame assembly may be configured to be held in place at least in some horizontal directions when the first set of guide members is within the vertical assembly.

In one aspect of the storage system, a distance between two neighboring upright members may be equal to or larger than a width of the access opening, such that any lifting frame assembly which can pass through the access opening of the rail system also can pass through the two neighboring upright members when the guide members are in the retracted position.

The storage system may further comprise an additional framework structure comprising upright members forming a storage volume comprising storage columns arranged in rows between the upright members, and wherein storage containers may be stacked one on top of one another to form stacks within the storage columns.

The storage area may comprise a combination of prior art stacking of containers with new storage system where storage containers can be placed on shelves provides the possibility of positioning a mini-load system on the outside of the main storage system where this mini-load system will have access to the storage containers from outside while the container lift device may have access from the top.

The storage system may further comprise a movable column comprising shelves for supporting one storage container on each shelf, and wherein the movable column is configured to be positioned within, at or adjacent the framework structure such that the lifting frame assembly can place storage containers onto or retrieve storage containers from the shelves.

A width of the access opening may be smaller than a distance between two adjacent upright members.

Furthermore, a width of the lifting frame may be smaller than a distance between two adjacent upright members such that the lifting frame can be moved through the two adjacent upright members.

It is further described a method of guiding a lifting frame assembly as defined above against upright members of a storage system, wherein the method comprises the steps of:
lowering the lifting frame assembly from a position above an underlying rail system to a position below the rail system while the first set of guide members are in a retracted position;
when the lifting frame assembly is at the position below the rail system, extending the first set of guide members from the retracted position within the outer periphery of the lifting frame holder to the extended position where the guide members extend outside the outer periphery of the lifting frame holder and are brought into contact with the upright members;
lowering the lifting frame assembly to a desired position while being guided by the first set of guide members against the upright members.

The method may further comprise the step of extending the first set of guide members towards and into contact with the upright members further comprises extending a second set of guide members towards and into contact with the upright members, wherein the second set of guide members are arranged at a vertical distance from the first set of guide members.

In an aspect of the method, the lifting frame assembly may further comprise a lifting frame holder connected with lifting bands to the container lift device and wherein the first set of guide members are connected to the lifting frame holder;
a horizontally movable telescopic part to which the lifting frame is connected; and wherein the method comprises the step of, while the first set of guide members are in contact with the upright members:
moving the telescopic part horizontally between a retracted position below the lifting frame holder and an extended position outside a vertical projection of the lifting frame holder.

If a second set of guide members is present, the second set of guide members is preferably also in contact with the upright members.

In order to stabilize the lifting frame holder against possible torque resulting from extending the telescopic part sideways even further, this step may also include to further push/lock/secure the first (and second) set of guide members towards the upright members. The torque in terms of allowable degrees deviating from horizontal may be between 0 and 10 degrees, more preferably between 0 and 5 degrees.

It is further described a framework structure comprising upright members supporting a two-dimensional rail system of the framework structure arranged across the top of framework structure, wherein the upright members are configured to guide members of a lifting frame assembly.

It is further described a storage system comprising a framework structure, the framework structure comprising upright members and a two-dimensional rail system arranged across the top of the upright members, the rail system comprises a first set of parallel rails arranged to guide movement of container handling vehicles in a first direction X across the top of the frame structure, and a second set of parallel rails arranged perpendicular to the first set of rails to guide movement of the container handling vehicles in a second direction Y which is perpendicular to the first direction, the first and second sets of parallel rails dividing the rail system into a plurality of access openings in the rail system for lifting and lowering of a storage container between a position above the rail system and a position below the rail system, and wherein the storage system comprises upright members supporting a two-dimensional rail system of the framework structure arranged across the top of framework structure, wherein the upright members are configured to guide members of a lifting frame assembly.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the storage system and the goods to be stored. The gripping recesses may be arranged at an upper rim of the sidewalls. The outer horizontal periphery of the storage container is preferably rectangular.

The lifting frame assembly, container handling vehicle, storage system and method may be used in connection with storage containers as described above. However, other areas where the disclosed storage system, container buffering assembly and methods may be used is within vertical farming, micro-fulfilment or grocery/e-grocery with or without need of cold zones.

The relative terms “upper”, “lower”, “below”, “above”, “higher” etc. shall be understood in their normal sense and as seen in a cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a top view of the cross section of a prior art upright member with an inwardly facing surface in the area of the upright member where the lifting frames are guided;

FIG. 6A is a side view of a storage system comprising, on the right hand side of the dividing line, prior art upright members and, on the left hand side of the dividing line, upright members having a convex surface for vertical guiding of guide members of the lifting frame assembly;

FIG. 6B is an enlarged view of a guide member in the form of a roller guided by an upright member having a convex surface;

FIG. 6C is a top view of a lifting frame holder of a lifting frame assembly and illustrates a rectangular horizontal outer periphery of the lifting frame holder;

FIG. 7A is a perspective view of a storage system comprising upright members according to prior art, upright members with convex surfaces for guiding of a lifting frame assembly, and a movable column comprising shelves for supporting one storage container on each shelf;

FIG. 7B is a perspective view of the storage system of FIG. 7A seen from another angle;

FIG. 7C is an enlarged view of section A in FIG. 7B;

FIG. 8 is a perspective view of a storage system comprising prior art upright members forming storage columns where storage containers can be stacked on top of each other, and upright members with convex surface forming a storage column with independent tiltable shelves in between the prior art storage columns, wherein the tiltable shelves in a first position thereof can support a storage container and in a second position allows storage containers to pass vertically therethrough;

FIG. 9 is a perspective view of a storage system comprising prior art upright members forming storage columns where storage containers can be stacked on top of each other and a transfer column in center formed by upright members with convex surface, wherein the transfer column is enclosed by four storage columns with stationary shelves for supporting a storage container on each of the shelves;

FIG. 10A is a side view of a lifting frame assembly with retractable and extendable guide members guided by upright members with convex surface;

FIG. 10B is an enlarged view of section B in FIG. 10A;

FIG. 10C is a perspective view from above of FIG. 10A;

FIG. 10D is an enlarged view of section C in FIG. 10C;

FIG. 11A is a top view of a lifting frame assembly and upright members with a convex surface, and wherein there are guide members in all four corners for guiding against the convex surface of the upright members, and wherein all of the guide members are in the extended position;

FIG. 11B is a top view of a lifting frame assembly and upright members with a convex surface, and wherein there are guide members in two opposite corners for guiding against the convex surfaces of the upright members and wherein both guide members are in the extended position;

FIG. 12A is a perspective view from above of a lifting frame assembly above the rail system with the guide members in the retracted position;

FIG. 12B is an enlarged view of section D in FIG. 12A;

FIG. 12C is a top view of FIG. 12A illustrating that the when in the retracted position, the guide members are within the outer periphery of a lifting frame holder of the lifting frame assembly and the lifting frame assembly can be transferred through an access opening in the rail system;

FIG. 13A is a perspective view from above of upright members with an outwardly protruding surface and where the lifting frame assembly comprises guide members in the form of a sliding pad which is guided against the convex surface of the upright members;

FIG. 13B is an enlarged view of section E in FIG. 13A;

FIG. 14A is a bottom view of the rail system and a storage container lifted by a lifting frame assembly and, where the lifting frame assembly comprises guide members in the form of a sliding pad in all four corners, where the sliding pads are guided against the outwardly protruding surface of the upright members;

FIG. 14B is a similar view as FIG. 14A but without the rail system;

FIG. 15A is a perspective view of the lifting frame assembly guided against upright members and where the lifting frame assembly comprises a lifting frame holder and a telescopic part, and wherein the telescopic part is configured to move between a retracted position below the lifting frame holder and an extended position outside a vertical projection of the lifting frame holder;

FIG. 15B is a perspective view of an example moving mechanism for moving the telescopic part 21 between the retracted position and the extended position;

FIG. 16A is a top view of a lifting frame assembly comprising a protruding member in the form of a tip or pin end and the upright member comprises a vertical groove, wherein the guide members is configured to be received in the complementary shaped vertical groove of the upright members;

FIG. 16B shows details of the upright member in FIG. 16A;

FIG. 17A is a side view of a storage system where two upright members are arranged on opposite longitudinal sides of a lifting frame assembly, the lifting frame assembly comprises extendable guide members for guiding against a surface of the upright members;

FIG. 17B shows the same as FIG. 17A seen from an angle 90 degrees relative FIG. 17A;

FIG. 17C is a perspective view from above of FIG. 17A;

FIG. 17D is an enlarged view of section F in FIG. 17C;

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

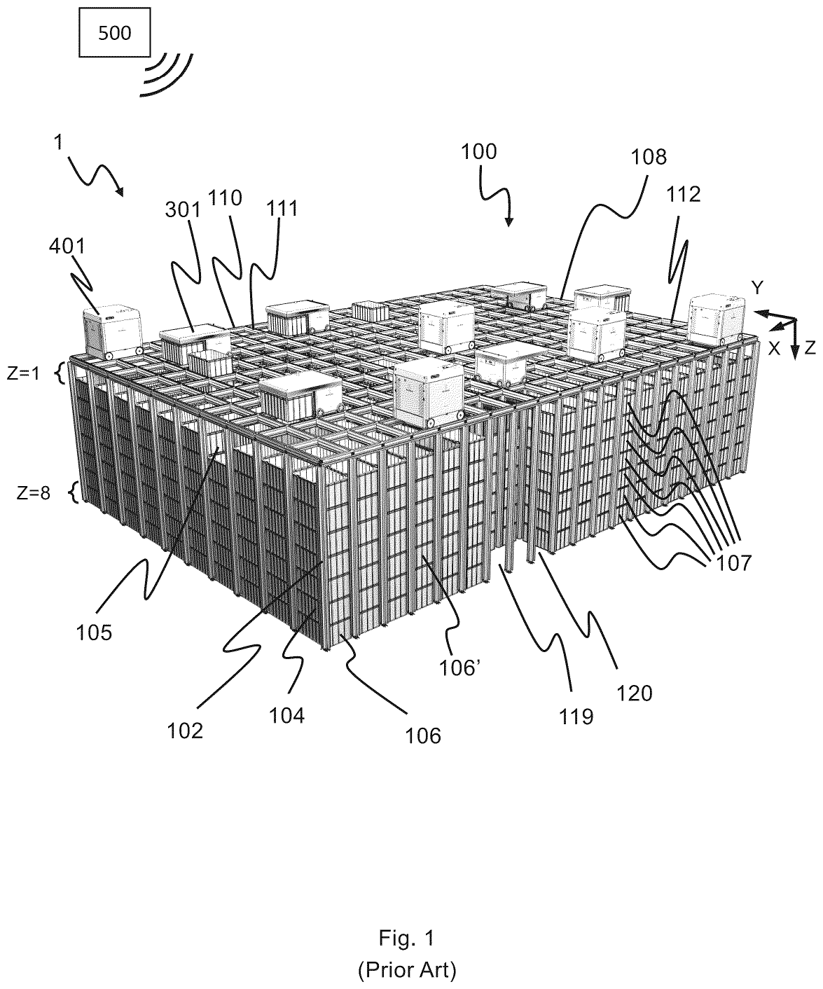

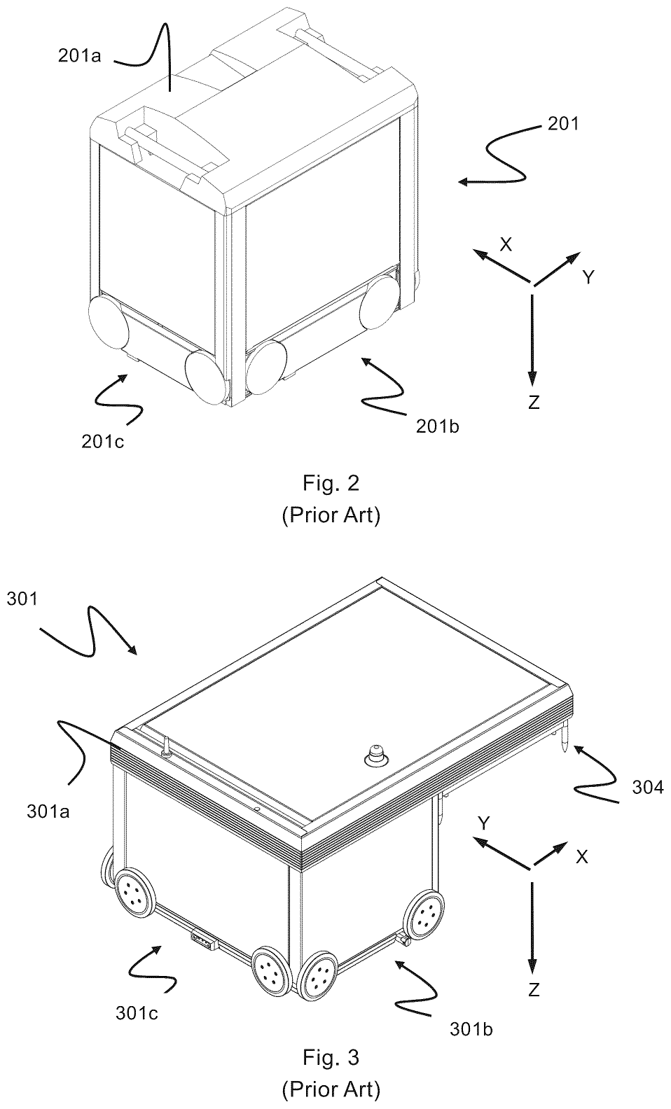

A framework structure 100 of the automated storage and retrieval system 1 may be constructed in a similar manner to the prior art framework structure 100 described above in connection with FIGS. 1-3. That is, the framework structure 100 may comprise a number of upright members 102, and comprise a first, upper rail system 108 extending in the X direction and Y direction.

The prior art framework structure 100 may further comprise storage compartments in the form of storage columns 105 provided between the members 102 wherein storage containers 106 may be stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

FIG. 5 is a top view of the cross section of a prior art upright member 102 with an inwardly facing surface (i.e. the corner 117 in FIG. 5) in the area of the upright member where the lifting frames are guided. The upright member 102 comprises vertical guide surfaces 116 (or vertical guide plates) for guiding a storage container being moved inside a storage column 105. In a storage column, each of the four upright members 102 provides an inside corner 117 for guiding a corresponding corner of a storage container 106. Typically, each upright member 105 features eight vertical guide surfaces 116 and may thus provide an inside corner 117 of four separate storage columns 112 of the storage grid 104.

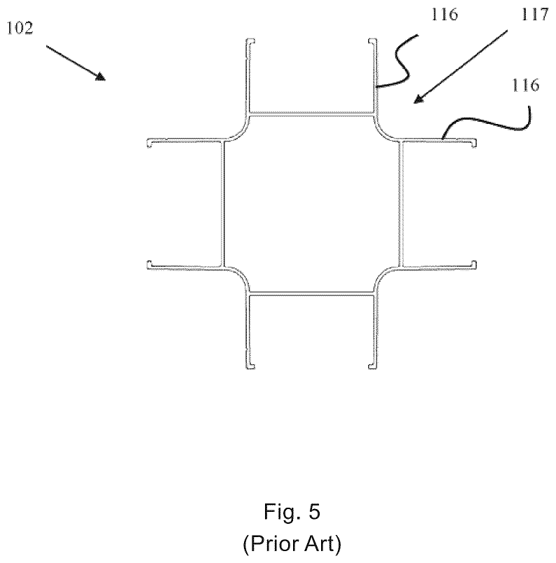

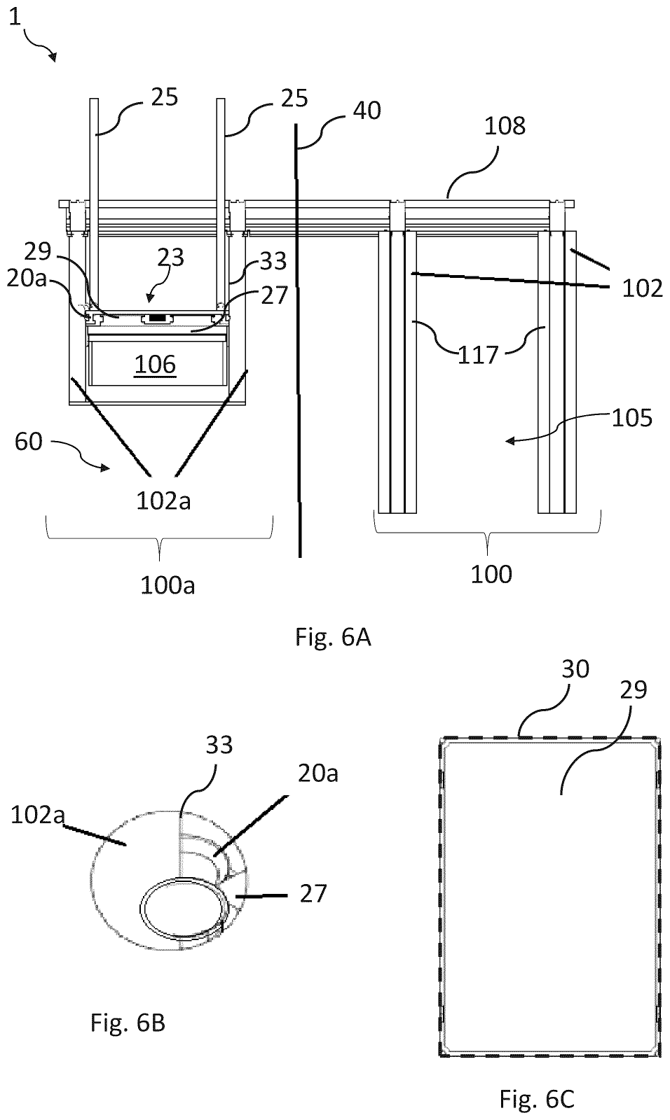

FIG. 6A is a side view of a storage system 1 comprising, on the right hand side of the dividing line 40, a prior art framework structure 100 with prior art upright members 102 with inside corners 117 forming prior art storage columns 105 and, on the left hand side of the dividing line 40, a new framework structure 100a with upright members 102a having an outwardly protruding surface 33, i.e. a convex surface 33, forming a transfer column 60 for vertical guiding of guide members 20a of the lifting frame assembly 23. The prior art framework structure 100 and the new framework structure 100a share a common rail system 108. In other words, the rail system 108 extends between the prior art framework structure 100 on the left hand side and the new framework structure 100a on the right hand side.

FIG. 6B is an enlarged view of a guide member 20a in the form of a roller 20a guided by an upright member 102a having a convex surface 33. The guide member 20a in FIG. 6A may be used in the lifting frame assembly shown in FIG. 6A.

FIG. 6C is a top view of a lifting frame holder 29 of a lifting frame assembly 23 and illustrates a rectangular horizontal outer periphery of the lifting frame holder 29. The rectangular horizontal outer periphery of the lifting frame holder 29 is shown by the dotted line 29.

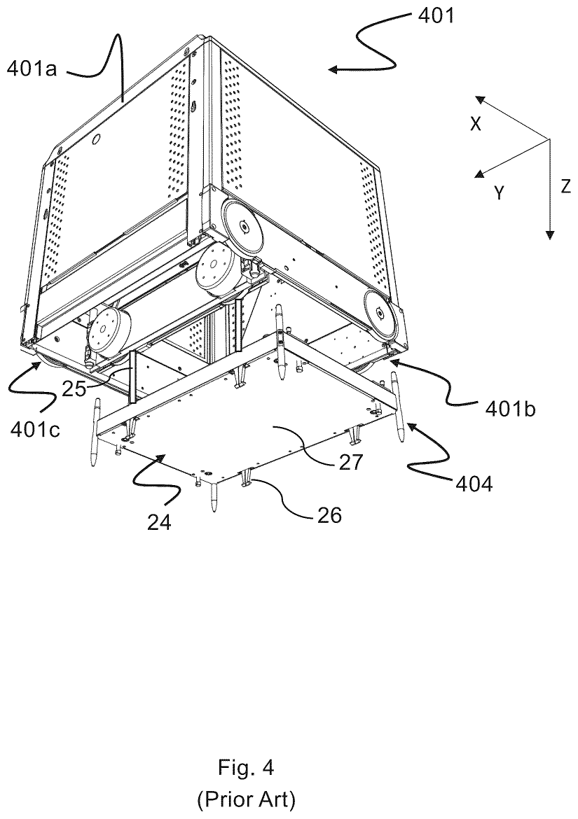

Now referring to FIGS. 6A-6C the lifting frame assembly 23 is connectable to a container lift device via the lifting bands 25 (container lift device not shown in FIG. 6A, but any of the prior art container handling vehicles 201,301,401 disclosed in FIGS. 1-4 or a gantry mounted lift device, or a fixed container lift device as disclosed in WO 2020/210558 A1 would be suitable). The lifting frame assembly 23 is disclosed with a lifting frame holder 29 configured to be suspended from the container lift device by the lifting bands 25. The lifting frame holder 29 has a rectangular horizontal outer periphery 30 (see FIG. 6C). A lifting frame 27 is connected to the lifting frame holder 29 and comprises gripping devices or grippers 26 for connection to the storage container 106 from above. The lifting frame assembly is further disclosed with a first set of guide members 20a for guiding against an outwardly protruding surface/convex surface 33 (see details in FIG. 6B) of the upright members 102a of the framework structure 100a. The first set of guide members 20a is operable between a retracted position where the guide members 20a are retracted within the outer periphery 30 of the lifting frame holder (29), and an extended position where the guide members 20a extend outside the outer periphery 30 of the lifting frame holder 29.

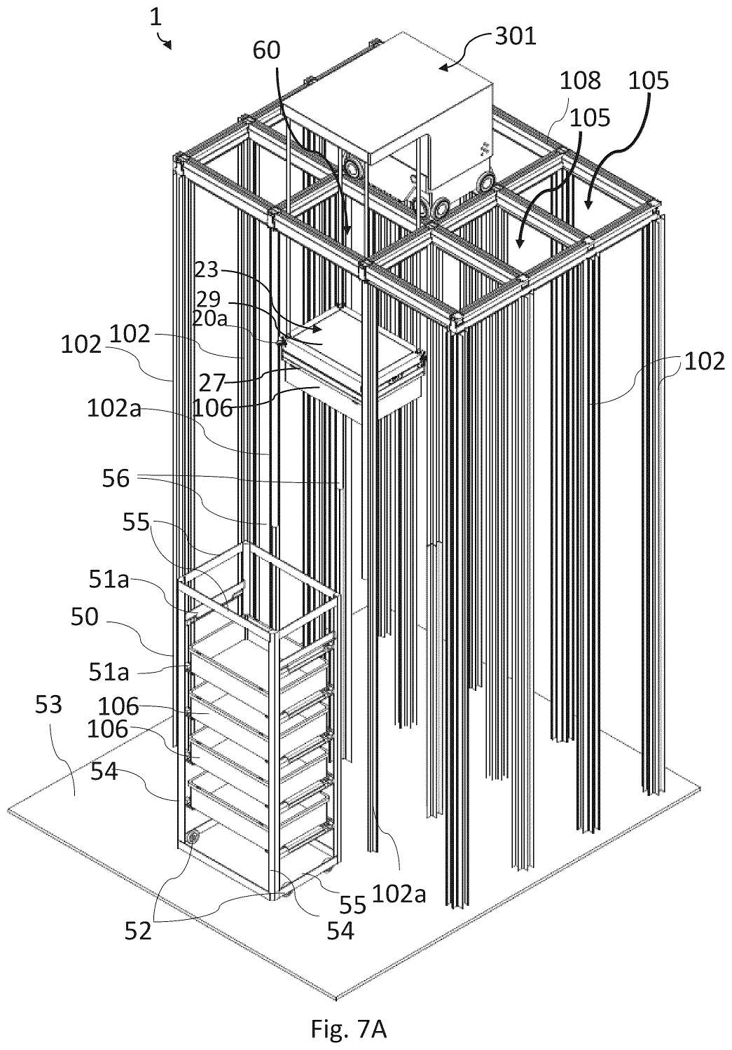

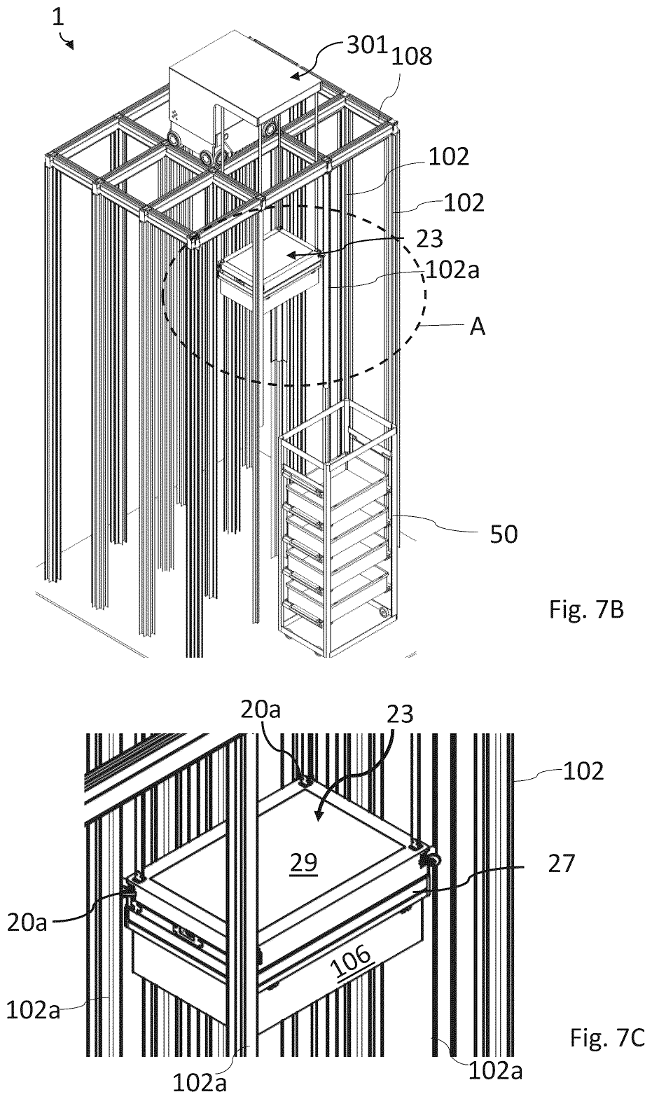

FIG. 7A is a perspective view of a storage system comprising prior art upright members 102 forming prior art storage columns 105, new upright members 102 with convex surfaces 33 forming a transfer column where the guide members 20a a lifting frame assembly 23 positioned in between the prior art upright members 102 and forming a column w, and a movable column 50 comprising shelves 51a for supporting one storage container 106 on each shelf 51a. The movable column 50 is disclosed comprising wheels 52 for transporting the movable column 50 on an underlying surface 53. However, other movement devices than wheels may be used, such as rollers, belt drive etc. The movable column 50 is disclosed adjacent to or next to the transfer column 105. The movable column 50 is disclosed with tiltable shelves 51a which allows for vertical passing of the lifting frame 23 assembly therethrough in order to position storage containers on shelves 51a below. When a shelf 51a shall change position to a “supporting position” in which it can support a storage container 106 from below, the tiltable shelf 51a is operable into a position where a horizontal cross section area is reduced to a size smaller than a horizontal cross section area of the storage containers 106 such that the lifting frame assembly with a storage container 106 connected thereto is obstructed from passing further downwards in the transfer column 60. In order to obtain the latter, the movable column 50 is preferably movable into the transfer column 50 such that the lifting frame assembly 23 suspended from a container lift device 301 can feed the shelves with storage containers directly. The movable column 50 may be in the form of a frame comprising four vertical supports 54 (one in each corner) and horizontal bars 55 in the X and Y directions connecting the vertical supports 54. The vertical supports 54 preferably have a similar shape as the upright members 102a of the transfer column 60 and may have an outwardly protruding surface, i.e. a convex surface, for guiding the extendible guide members 20a of the lifting frame assembly 23. As can be seen in FIG. 7A, the outwardly protruding surface 33 of the upright members 102a finish short at an end point 55 in order to make space for the movable column 50 below.

In the illustration in FIG. 7A, the transfer column 60 is arranged in between storage columns 105 on three of the sides thereof and an open space on the fourth side (i.e. the side where the movable column 50 is position in FIG. 7A).

FIG. 7B is a perspective view of the storage system of FIG. 7A seen from another angle.

FIG. 7C is an enlarged view of section A in FIG. 7B showing the lifting frame assembly 23 with lifting frame holder 29, lifting frame 27, guide members 20a in the extended position extending outside an outer periphery of the lifting frame holder 29 in contact with the upright members 102a. The lifting frame 27 supports a storage container 106.

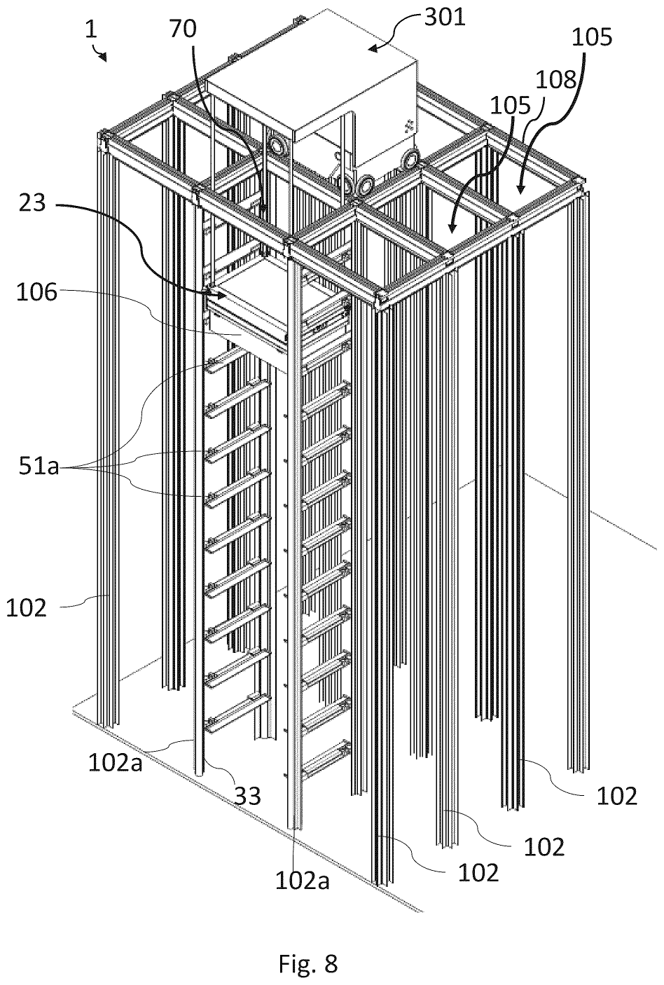

FIG. 8 is a perspective view of a storage system 1 comprising prior art upright members 102 forming storage columns 105 where storage containers 106 can be stacked on top of each other, and upright members 102a with convex surface 33 forming a storage column with independent tiltable shelves 51a in between the prior art storage columns 105. The tiltable shelves 51a may be similar to the tiltable shelves disclosed and described in relation to FIG. 7A, i.e. in a first position the tiltable shelves 51a can support a storage container 106, and in a second position the tiltable shelves 51a allows a lifting frame assembly 23 and storage containers 106 to pass vertically therethrough. The example in FIG. 8 has many features in common with FIGS. 7A and 7B, except that the movable column 50 with tiltable shelves 51a in FIGS. 7A and 7B has been replaced with a stationary storage column 70 with tiltable shelves 51a.

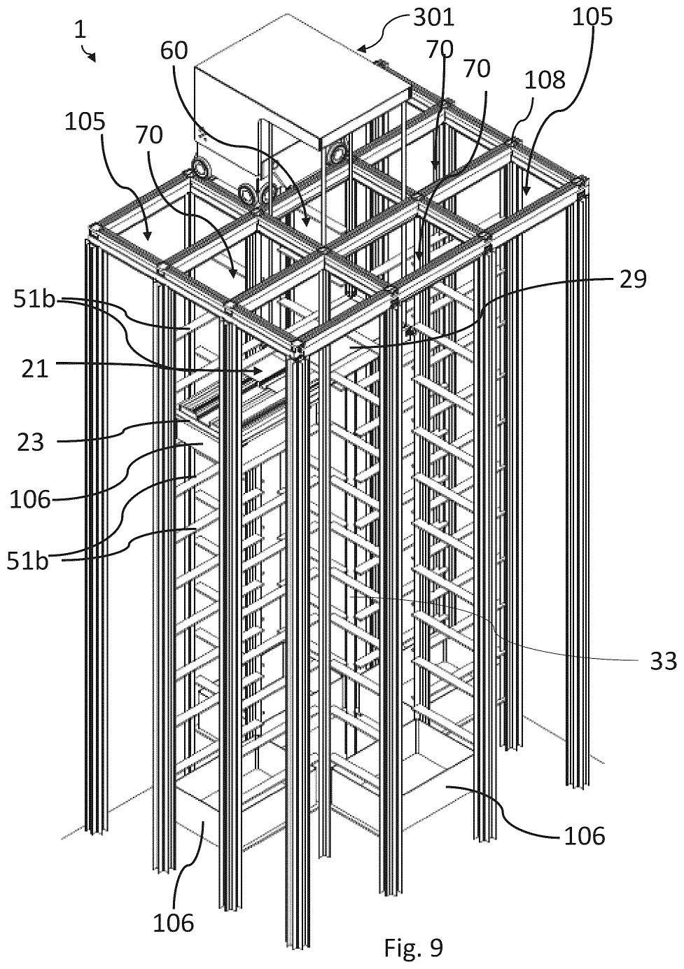

FIG. 9 is a perspective view of a storage system 1 comprising prior art upright members 102 forming storage columns 105 where storage containers 106 can be stacked on top of each other and a transfer column 60 in center formed by upright members 102a with convex surface 33, wherein the transfer column 60 is enclosed by four storage columns 70 with stationary shelves 51b for supporting a storage container 106 on each of the shelves 51b. The lifting frame assembly 23 in FIG. 9 comprises a horizontally movable telescopic part 21 to which the lifting frame 27 is connected. The telescopic part 21 is configured to move between a retracted position below the lifting frame holder 29 and an extended position outside a vertical projection of the lifting frame holder 29. In FIG. 9, the telescopic part 21 is in the extended position outside the vertical projection of the lifting frame holder 29. The telescopic part 21 renders possible that a storage container 106 can be transported horizontally between adjacent columns 60,70 through two adjacent upright members 102a. However, in order for the horizontal movement through an area between two adjacent upright members 102a to be possible, the upright members 102a forming the framework structure 102a between the columns 60, 70 where the storage container 106 is to be transported horizontally, have to be of another design than the prior art upright members 102 in order to provide a sufficiently large cross sectional area for the telescopic part 21, the lifting frame 27 and a supported storage container 106 to pass therethrough.

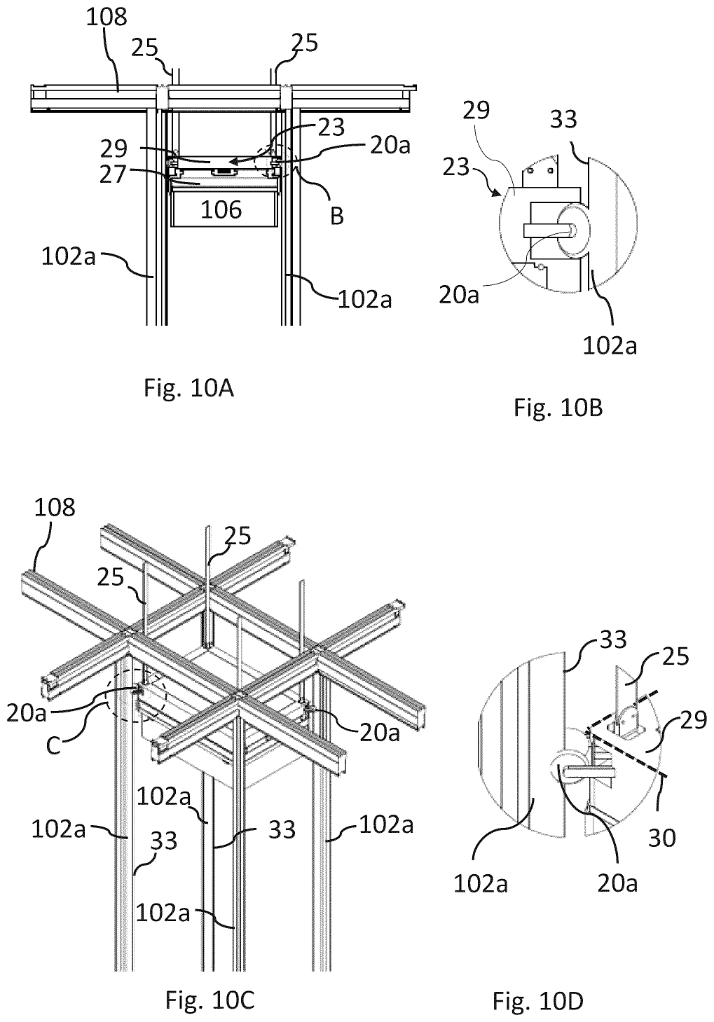

FIG. 10A is a side view of a lifting frame assembly 23 with retractable and extendable guide members in the form of rollers 20a guided by upright members 102a with convex surface 33.

FIG. 10B is an enlarged view of section B in FIG. 10A. The roller 20a in FIG. 10B is in the extended position outside the outer periphery of the lifting frame holder 29.

FIG. 10C is a perspective view from above of FIG. 10A.

FIG. 10D is an enlarged view of section C in FIG. 10C. The roller 20a in FIG. 10D is in the extended position outside the outer periphery 30 of the lifting frame holder 29 (illustrated by the dotted line).

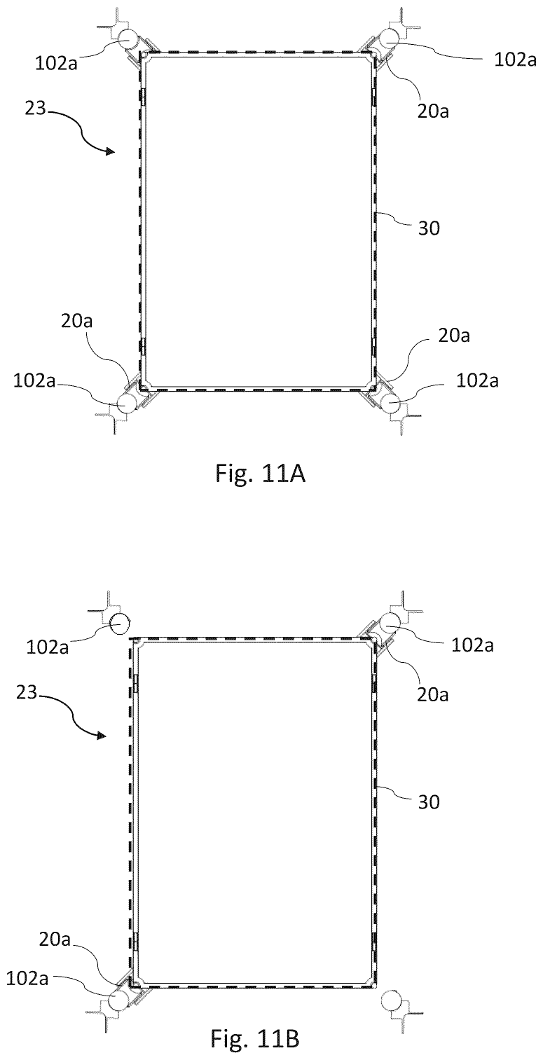

FIG. 11A is a top view of a lifting frame assembly 23 and upright members 102a with a convex surface 33. The lifting frame assembly 23 in FIG. 11A has guide members 20a in all four corners for guiding against the convex surfaces 33 of the upright members 102a. In the example in FIG. 11A, all of the guide members 20a are in the extended position where they extend outside the outer periphery 30 (illustrated by the dotted line) of the lifting frame holder 29.

FIG. 11B is a top view of a lifting frame assembly 23 and upright members 102a with a convex surface 33. The lifting frame assembly 23 gas guide members 20a in two opposite corners for guiding against the convex surfaces 33 of the upright members 102a. In the example in FIG. 11A, both of the guide members 20a are in the extended position where they extend outside the outer periphery 30 (illustrated by the dotted line) of the lifting frame holder 29.

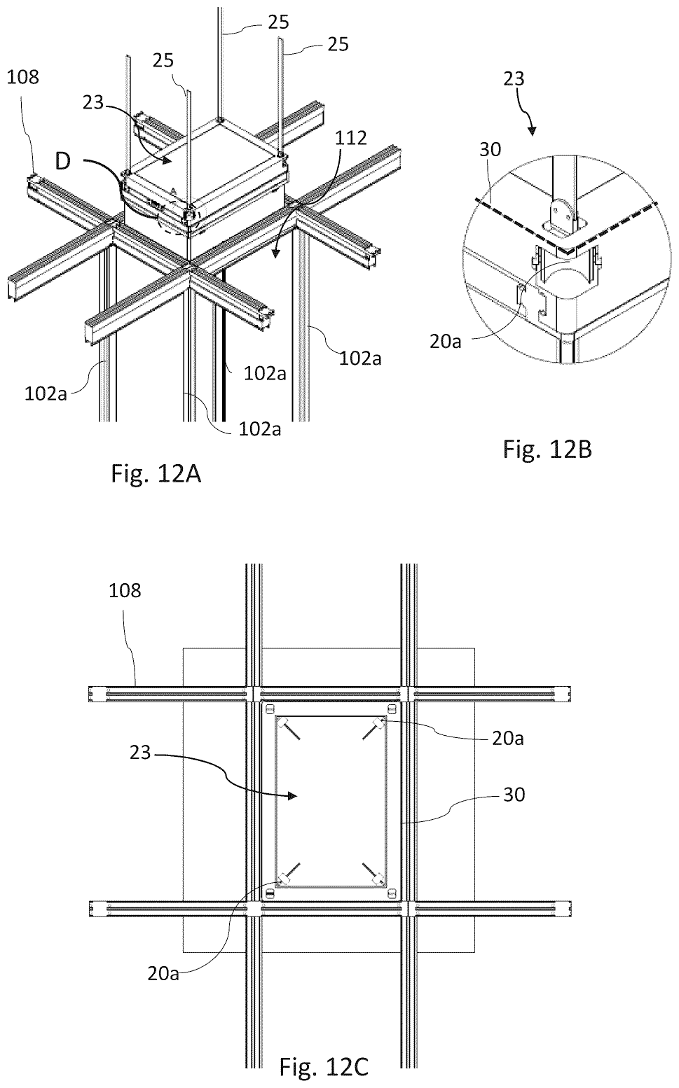

FIG. 12A is a perspective view from above of a lifting frame assembly 23 above the rail system with the guide members in the retracted position. The lifting frame assembly 23 is suspended from a container lift device (not shown) via the lifting bands 25. Due to the fact that the cross sectional area of the access opening 112 in the rail system 108 is smaller than the cross sectional area of a modified transfer column 60 (or stationary storage column 70 with tiltable shelves), the guide members 20a have to be retractable to a retracted position where the guide members 20a are retracted within the outer periphery 30 of the lifting frame holder 29 in order to be able to pass through the access opening 112 of the rail system 108.

FIG. 12B is an enlarged view of section D in FIG. 12A.

FIG. 12C is a top view of FIG. 12A illustrating that the when in the retracted position, the guide members 20a are within the outer periphery 30 of a lifting frame holder of the lifting frame assembly 23 and the lifting frame assembly can be transferred through an access opening 112 in the rail system 108.

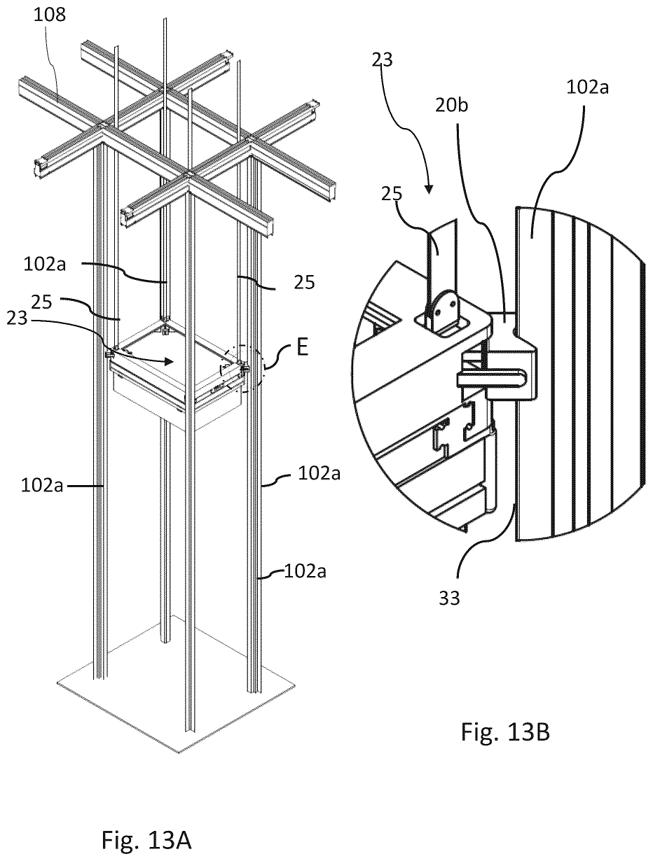

FIG. 13A is a perspective view from above of upright members with an outwardly protruding surface and where the lifting frame assembly 23 comprises guide members in the form of a sliding pad 20b which is guided against the convex surface 33 of the upright members 102a.

FIG. 13B is an enlarged view of section E in FIG. 13A.

The example in FIGS. 13A and 13B is identical to the example in FIGS. 10A-10D, 11A-11B and 12A-12C except in FIGS. 13A and 13B the guide member 20b is a sliding pad 20b whereas in FIGS. 10A-10D, 11A-11B and 12A-12C the guide member 20a is a roller 20a.

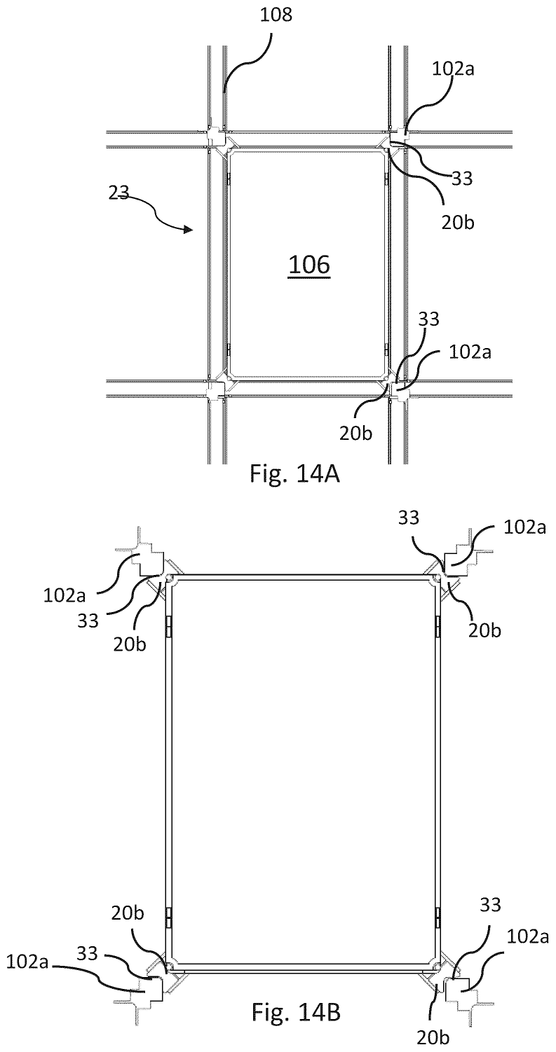

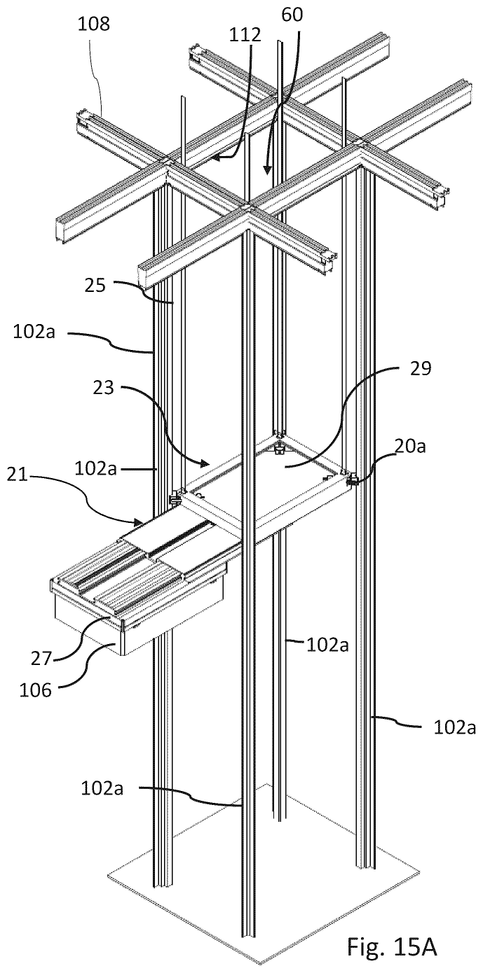

FIG. 14A is a bottom view of the rail system 108 and a storage container 106 lifted by a lifting frame assembly 23 and, where the lifting frame assembly comprises guide members in the form of a sliding pad 20b in all four corners, where the sliding pads 20b are guided against the convex or outwardly protruding surface 33 of the upright members 102a.

FIG. 14B is a similar view as FIG. 14A but without the rail system 108.

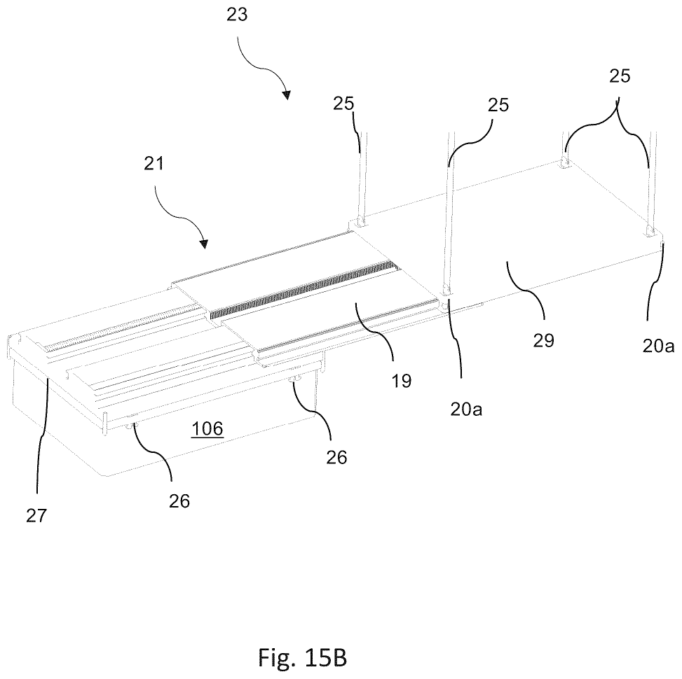

FIG. 15A is a perspective view of the lifting frame assembly 23 guided against upright members 102a and where the lifting frame assembly comprises a lifting frame holder 29 and a telescopic part 21, and wherein the telescopic part 21 is configured to move between a retracted position below the lifting frame holder 29 and an extended position outside a vertical projection of the lifting frame holder 29. As illustrated in FIG. 9, the lifting frame assembly 23 comprises a horizontally movable telescopic part 21 to which the lifting frame 27 is connected. The telescopic part 21 is configured to move between a retracted position below the lifting frame holder 29 and an extended position outside a vertical projection of the lifting frame holder 29. In FIG. 15A, the telescopic part 21 is in the extended position outside the vertical projection of the lifting frame holder 29. The telescopic part 21 renders possible that a storage container 106 can be transported horizontally or sideways between adjacent columns through two adjacent upright members 102a. However, in order for the horizontal movement through an area between two adjacent upright members 102a to be possible, the upright members 102a have to be of another design than the prior art upright members 102 in order to provide a sufficiently large cross sectional area for the telescopic part 21, the lifting frame 27 and a supported storage container 106 to pass therethrough.

FIG. 15B is a perspective view of an example moving mechanism for moving the telescopic part 21 between the retracted position and the extended position. In addition, the figures show stabilizing means on the lifting frame holder 29 for securing the lifting frame holder 29 in the transfer column 60 during extension of the telescopic part 19 to prevent tilting of the lifting frame 27. In FIG. 15B the telescopic part 19 is in a fully extended position.

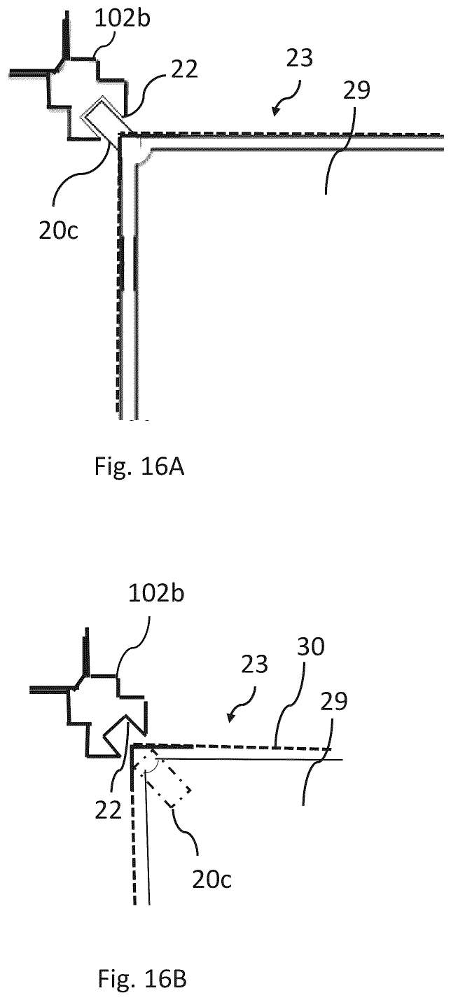

FIG. 16A is a top view of a lifting frame assembly 23 comprising a protruding member 20c in the form of a tip 20c or pin end 20c. The upright member 102b comprises a vertical groove 22 extending from an upper part of the upright members 102b and to a lower part of the upright members 102b. The guide members 20c are configured to be received in the complementary shaped vertical groove 22 of the upright members 102b. As indicated in FIG. 16A, the guide member 20c is in the extended position where it extends outside the outer periphery 30 of the lifting frame holder 29.

FIG. 16B shows details of the upright member in FIG. 16A.

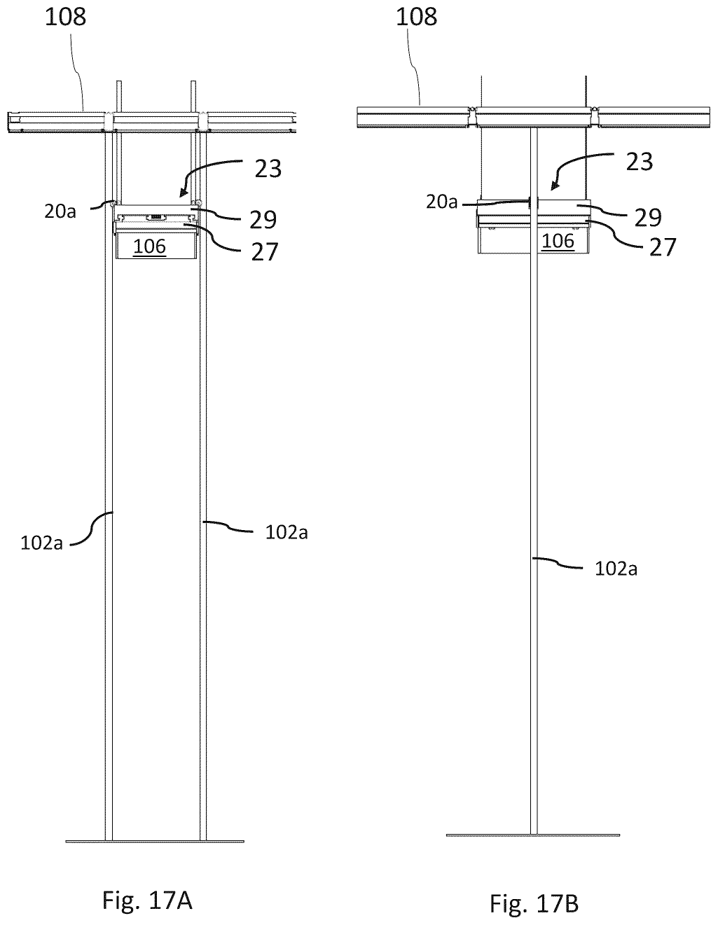

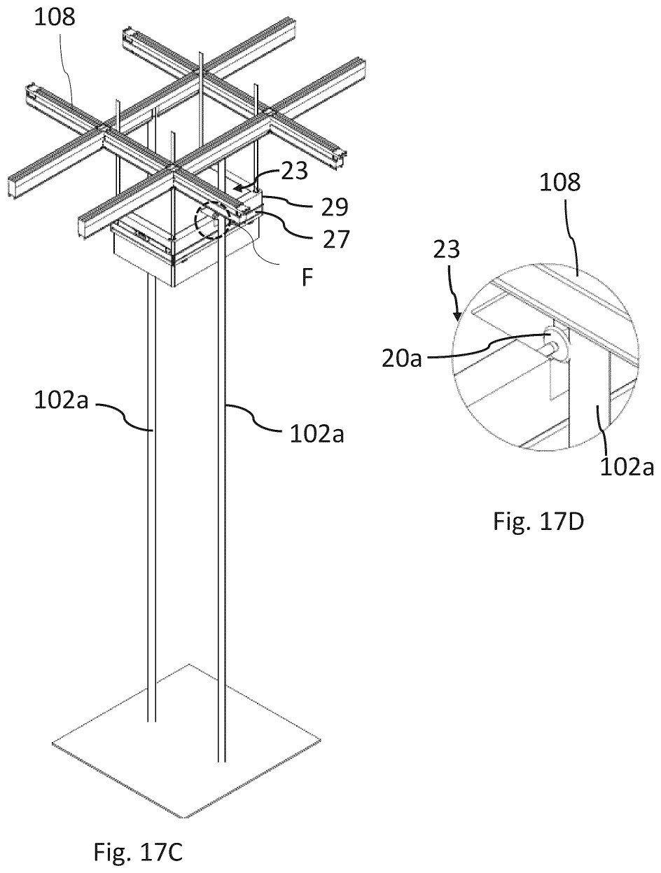

FIG. 17A is a side view of a storage system where two upright members 102a are arranged on opposite longitudinal sides of a lifting frame assembly 23, the lifting frame assembly 23 comprises extendable guide members 20a for guiding against a surface of the upright members 102a.

FIG. 17B shows the same as FIG. 17A seen from an angle 90 degrees relative FIG. 17A.

FIG. 17C is a perspective view from above of FIG. 17A;

FIG. 17D is an enlarged view of section F in FIG. 17C showing the guide member in the form of a roller 20a.

In the preceding description, various aspects of the storage system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

Some aspects of the invention are set out in the following numbered clauses.

Clause 1. A lifting frame assembly (23) for a container lift device (201,301,401) of an automated storage system (1), wherein the lifting frame assembly (23) comprises:
a lifting frame holder (29) configured to be suspended from the container lift device by lifting bands (25), wherein the lifting frame holder (29) has a rectangular horizontal outer periphery (30);
a lifting frame (27) comprising grippers (26) for connection to a storage container (106) from above;
at least a first set of guide members (20a,20b,20c) for guiding against upright members (102a; 102b) of a framework structure (100a) of the automated storage system (1), and wherein the first set of guide members (20a,20b,20c) is operable between:
a retracted position where the guide members (20a,20b,20c) are retracted within the outer periphery (30) of the lifting frame holder (29), and an extended position where the guide members (20a,20b,20c) extend outside the outer periphery (30) of the lifting frame holder (29).

Clause 2. The lifting frame assembly (23) according to clause 1, wherein the first set of guide members (20a,20b,20c) comprises two guide members (20a,20b,20c) arranged in two oppositely arranged corners.

Clause 3. The lifting frame assembly (23) according to clause 1, wherein the first set of guide members (20a,20b,20c) comprises four guide members, where one guide member is arranged in each corner.

Clause 4. The lifting frame assembly (23) according to any of the preceding clauses, wherein the first set of guide members (20a,20b,20c) are arranged on two oppositely arranged side edges of the lifting frame assembly (23).

Clause 5. The lifting frame assembly (23) according to any of the preceding clauses, wherein the first set of guide members (20a,20b) have a concave surface.

Clause 6. The lifting frame assembly (23) according to any of the preceding clauses 1-4, wherein the first set of guide members (20c) comprises a protruding member (20c) configured to be received in a complementary vertical groove (22) of the upright members (102b).

Clause 7. The lifting frame assembly (23) according to any of the preceding clauses, further comprising a second set of guide members arranged at a vertical distance from the first set of guide members.

Clause 8. The lifting frame assembly (23) according to clause 7, wherein the second set of guide members comprises an equal amount of guide members as the first set of guide members.

Clause 9. The lifting frame assembly (23) according to any of the preceding clauses, further comprising:
a horizontally movable telescopic part (21) to which the lifting frame (27) and the lifting frame holder (29) is connected;
and wherein the telescopic part (21) is configured to move between a retracted position below the lifting frame holder (29) and an extended position outside a vertical projection of the lifting frame holder (29).

Clause 10. The lifting frame assembly (23) according to clause 9, wherein the lifting frame holder (29) is linked to the lifting frame (27) by the telescopic part (21) joining one to the other.

Clause 11. A container handling vehicle (201,301,401) for a storage system, wherein the container handling vehicle (401) comprises a first set of wheels for driving in a first direction (x) and a second set of wheels for driving in a second direction (y) perpendicular to the first direction, wherein the container handling vehicle comprises a lifting frame assembly (23) according to any of the preceding claims 1-10.

Clause 12. A framework structure (100a) comprising upright members (102a; 102b) supporting a two-dimensional rail system (108) of the framework structure (100a) arranged across the top of the upright members (102a; 102b), wherein the upright members (102a; 102b) are configured to guide the first set of guide members (20a,20b,20c) of the lifting frame assembly (23) according to any of the preceding clauses 1-10.

Clause 13. The framework structure (100a) according to clause 12, wherein the upright members (102a) each have a convex surface (33).

Clause 14. The framework structure (100a) according to clause 12 or 13, wherein the upright members (102b) each comprise a vertical groove (22) extending from an upper part of the upright member (102b) and to a lower part of the upright member (102b).

Clause 15. A storage system (1) comprising a framework structure (100), the framework structure (100) comprising upright members (102) and a two-dimensional rail system (108) arranged across the top of the upright members (102), the rail system (108) comprises a first set of parallel rails (110) arranged to guide movement of container handling vehicles (201,301,401) in a first direction (x) across the top of the frame structure (100), and a second set of parallel rails (111) arranged perpendicular to the first set of rails (110) to guide movement of the container handling vehicles (401) in a second direction (y) which is perpendicular to the first direction, the first and second sets of parallel rails (110,111) dividing the rail system (108) into a plurality of access openings (112) in the rail system (108) for lifting and lowering of a storage container (106) between a position above the rail system (108) and a position below the rail system (108), and wherein the storage system (1) comprises a lifting frame assembly (23) according to claim 1-10, a container handling vehicle (201,301,401) according to claim 11 and/or a framework structure (100a) according to clause 12-14.

Clause 16. The storage system (1) according to clause 15, wherein the upright members of the framework structure (100a) each have a convex or outwardly protruding surface (33) and the first set of guide members (20a,20b) each have a concave surface oriented against the upright members (102a) such that the first set of guide members (20a,20b) at least partly enclose the upright members (102a) when in the extended position.

Clause 17. The storage system (1) according to claim 15 or 16, wherein the upright members (102b) each comprise a vertical groove (22) and the first set of guide members (20c) each comprise a complementary protruding member (20c).

Clause 18. The storage system according to any of the preceding clauses 15-17, wherein a distance between two neighboring upright members (102a, 102b) is equal to or larger than a width of the access opening (112), such that any lifting frame assembly (23) which can pass through the access opening (112) of the rail system also can pass through the two neighboring upright members (102a, 102b) when the first set of guide members (20a,20b,20c) are in the retracted position.

Clause 19. The storage system according to any of the preceding clauses 15-18, further comprising an additional framework structure (100) comprising upright members (102) forming a storage volume comprising storage columns (105) arranged in rows between the upright members (102), and wherein storage containers (106) are stacked one on top of one another to form stacks (107) within the storage columns (105).

Clause 20. The storage system according to any of the preceding clauses 15-19, further comprising a movable column (50) comprising shelves (51a) for supporting one storage container (106) on each shelf, and wherein the movable column (50) is configured to be positioned within, at or adjacent the framework structure such that the lifting frame assembly (23) can place storage containers (106) onto or retrieve storage containers from the shelves (51a,51b).

Clause 21. The storage system according to any of the preceding clauses 15-20, wherein a width of the access opening (112) is smaller than a distance between two adjacent upright members (102a, 102b).

Clause 22. The storage system according to any of the preceding clauses 15-21, wherein a width of the lifting frame (27) is smaller than a distance between two adjacent upright members (102a, 102b) such that the lifting frame (27) can be moved through the two adjacent upright members (102a, 102b).

Clause 23. Method of guiding a lifting frame assembly (23) according to any of the preceding clauses 1-10 against upright members (102a, 102b) of a storage system (1), wherein the method comprises the steps of:
lowering the lifting frame assembly (23) from a position above an underlying rail system (108) to a position below the rail system (108) while the first set of guide members (20a,20b20c) are in a retracted position;
when the lifting frame assembly (23) is at the position below the rail system (108), extending the first set of guide members (20a,20b,20c) from the retracted position within the outer periphery (30) of the lifting frame holder (29) to the extended position where the guide members (20a,20b,20c) extend outside the outer periphery (30) of the lifting frame holder (29) and are brought into contact with the upright members (102a, 102b);
lowering the lifting frame assembly (23) to a desired position while being guided by the first set of guide members (20a,20b,20c) against the upright members (102a, 102b).

Clause 24. The method according to clause 23, wherein the step of extending the first set of guide members (20a,20b,20c) towards and into contact with the upright members (102a, 102b) further comprises extending a second set of guide members towards and into contact with the upright members, wherein the second set of guide members are arranged at a vertical distance from the first set of guide members.

Clause 25. The method according to any of the preceding clauses 23 or 24, wherein the lifting frame assembly (23) further comprises:

a horizontally movable telescopic part (21) to which the lifting frame (23) is connected; and wherein the method comprises the step of, while the first set of guide members (20a,20b,20c) are in contact with the upright members (102a, 102b):

moving the telescopic part (21) horizontally between a retracted position below the lifting frame holder (29) and an extended position outside a vertical projection (30) of the lifting frame holder (29). List of reference numbers

| | |
|---|---|
| 1 | Prior art automated storage and retrieval system |
| 20a | Guide member/roller |
| 20b | Guide member/sliding pads |
| 20c | Guide member/protruding member/pin/tip |
| 21 | Telescopic part |
| 22 | Vertical groove |
| 23 | Lifting frame assembly |
| 24 | Lifting device |
| 25 | Lifting bands |
| 26 | Gripping device/grippers |
| 27 | Lifting frame |
| 28 | Gripping recess for gripping device |
| 29 | Lifting frame holder |
| 30 | Rectangular horizontal outer periphery of the lifting frame holder |
| 33 | Outwardly protruding surface/convex surface |
| 40 | Dividing line |
| 50 | Movable column |
| 51a | Tiltable shelf |
| 51b | Static shelf |
| 52 | Wheels on movable column |
| 53 | Underlying surface/floor |
| 54 | Vertical supports |
| 55 | Horizontal bar |
| 56 | End point |
| 60 | Transfer column |
| 70 | Stationary storage column with tiltable shelves |
| 100 | Framework structure (prior art) |
| 100a | Framework structure (outwardly protruding surface of upright |
| | members) |
| 102 | Upright members of framework structure (prior art) |
| 102a | Upright members with convex surface/Upright members with |
| | outwardly protruding surface |
| 102b | Upright members with vertical groove |
| 104 | Storage grid |
| 105 | Storage column |
| 106 | Storage container |
| 106′ | Particular position of storage container |
| 107 | Stack |
| 108 | Rail system (upper) |
| 110 | Parallel rails in first direction (X) |
| 112 | Access opening |
| 116 | Vertical guide surface of prior art upright member |
| 117 | Inside corner of a prior art upright member |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels in first |
| | direction (X) |
| 201c | Drive means/wheel arrangement/second set of wheels in second |
| | direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 501 | Prior art delivery vehicle |
| 501a | Vehicle body of the delivery vehicle 501 |
| 501b | Drive means/first set of wheels in first direction (X) |
| 501c | Drive means/second set of wheels in second direction (Y) |
| A | Section A |
| A-A | Section A-A |
| B | Section B |
| X | First direction |
| Y | Second direction |
| Z | Third direction |

1. A lifting frame assembly for a container lift device of an automated storage system, wherein the lifting frame assembly comprises:
a lifting frame holder configured to be suspended from the container lift device by lifting bands, wherein the lifting frame holder has a rectangular horizontal outer periphery;
a lifting frame comprising grippers for connection to a storage container from above;
at least a first set of guide members for guiding against upright members of a framework structure of the automated storage system, and wherein the first set of guide members is operable between:
a retracted position where the guide members are retracted within the outer periphery of the lifting frame holder, and
an extended position where the guide members extend outside the outer periphery of the lifting frame holder.

2. The lifting frame assembly according to claim 1, wherein the first set of guide members comprises two guide members arranged in two oppositely arranged corners.

3. The lifting frame assembly according to claim 1, wherein the first set of guide members comprises four guide members, where one guide member is arranged in each corner.

4. The lifting frame assembly according to claim 1, wherein the first set of guide members are arranged on two oppositely arranged side edges of the lifting frame assembly.

5. The lifting frame assembly according to claim 1, wherein the first set of guide members have a concave surface.

6. The lifting frame assembly according to claim 1, wherein the first set of guide members comprises a protruding member configured to be received in a complementary vertical groove of the upright members.

7. The lifting frame assembly according to claim 1, further comprising a second set of guide members arranged at a vertical distance from the first set of guide members.

8. The lifting frame assembly according to claim 7, wherein the second set of guide members comprises an equal amount of guide members as the first set of guide members.

9. The lifting frame assembly according to claim 1, further comprising:
a horizontally movable telescopic part to which the lifting frame and the lifting frame holder is connected;
and wherein the telescopic part is configured to move between a retracted position below the lifting frame holder and an extended position outside a vertical projection of the lifting frame holder.

10. The lifting frame assembly according to claim 9, wherein the lifting frame holder is linked to the lifting frame by the telescopic part joining one to the other.

11. A container handling vehicle for a storage system, wherein the container handling vehicle comprises a first set of wheels for driving in a first direction and a second set of wheels for driving in a second direction perpendicular to the first direction, wherein the container handling vehicle comprises a lifting frame assembly according to claim 1.

12. A framework structure comprising upright members supporting a two-dimensional rail system of the framework structure arranged across the top of the upright members, wherein the upright members are configured to guide the first set of guide members of the lifting frame assembly according to claim 1.

13. The framework structure according to claim 12, wherein the upright members each have a convex surface.

14. The framework structure according to claim 12, wherein the upright members each comprise a vertical groove extending from an upper part of the upright member and to a lower part of the upright member.

15. A storage system comprising a framework structure, the framework structure comprising upright members and a two-dimensional rail system arranged across the top of the upright members, the rail system comprises a first set of parallel rails arranged to guide movement of container handling vehicles in a first direction across the top of the frame structure, and a second set of parallel rails arranged perpendicular to the first set of rails to guide movement of the container handling vehicles in a second direction which is perpendicular to the first direction, the first and second sets of parallel rails dividing the rail system into a plurality of access openings in the rail system for lifting and lowering of a storage container between a position above the rail system and a position below the rail system, and wherein the storage system comprises a lifting frame assembly, a container handling vehicle, and/or a framework structure,
wherein the lifting frame assembly comprises:
a lifting frame holder configured to be suspended from the container lift device by lifting bands, wherein the lifting frame holder has a rectangular horizontal outer periphery;
a lifting frame comprising grippers for connection to a storage container from above;
at least a first set of guide members for guiding against upright members of a framework structure of the automated storage system, and wherein the first set of guide members is operable between:
a retracted position where the guide members are retracted within the outer periphery of the lifting frame holder, and
an extended position where the guide members extend outside the outer periphery of the lifting frame holder,
wherein the container handling vehicle comprises a first set of wheels for driving in a first direction and a second set of wheels for driving in a second direction perpendicular to the first direction, wherein the container handling vehicle comprises the lifting frame assembly, and
wherein the framework structure comprises upright members supporting a two-dimensional rail system of the framework structure arranged across the top of the upright members, wherein the upright members are configured to guide the first set of guide members of the lifting frame assembly.

16. (canceled)

17. The storage system according to claim 15, wherein the upright members each comprise a vertical groove and the first set of guide members each comprise a complementary protruding member.

18. The storage system according to claim 15, wherein a distance between two neighboring upright members is equal to or larger than a width of the access opening, such that any lifting frame assembly which can pass through the access opening of the rail system also can pass through the two neighboring upright members when the first set of guide members are in the retracted position.

19. The storage system according to claim 15, further comprising an additional framework structure comprising upright members forming a storage volume comprising storage columns arranged in rows between the upright members, and wherein storage containers are stacked one on top of one another to form stacks within the storage columns.

20. The storage system according to claim 15, further comprising a movable column comprising shelves for supporting one storage container on each shelf, and wherein the movable column is configured to be positioned within, at or adjacent the framework structure such that the lifting frame assembly can place storage containers onto or retrieve storage containers from the shelves.

21. (canceled)

22. (canceled)

23. A method of guiding a lifting frame assembly against upright members of a storage system, wherein the lifting frame assembly comprises:
a lifting frame holder configured to be suspended from the container lift device by lifting bands, wherein the lifting frame holder has a rectangular horizontal outer periphery;
a lifting frame comprising grippers for connection to a storage container from above;
at least a first set of guide members for guiding against upright members of a framework structure of the automated storage system, and wherein the first set of guide members is operable between:
a retracted position where the guide members are retracted within the outer periphery of the lifting frame holder, and
an extended position where the guide members extend outside the outer periphery of the lifting frame holder,
wherein the method comprises:
lowering the lifting frame assembly from a position above an underlying rail system to a position below the rail system while the first set of guide members are in a retracted position;
when the lifting frame assembly is at the position below the rail system, extending the first set of guide members from the retracted position within the outer periphery of the lifting frame holder to the extended position where the guide members extend outside the outer periphery of the lifting frame holder and are brought into contact with the upright members;
lowering the lifting frame assembly to a desired position while being guided by the first set of guide members against the upright members.

24. (canceled)

25. (canceled)
